(19) United States
(12) Patent Application Publication
(10) Pub. No.: US 2020/0124387 A1
(43) Pub. Date: Apr. 23, 2020

(54) ACHIEVING DESIRED BULLET PULL STRENGTH USING ADHESIVE SEALANTS AND RELATED METHODS

(71) Applicant: Harry Arnon, Sanford, FL (US)

(72) Inventor: Harry Arnon, Sanford, FL (US)

(21) Appl. No.: 16/658,859

(22) Filed: Oct. 21, 2019

Related U.S. Application Data
(60) Provisional application No. 62/747,947, filed on Oct. 19, 2018.

(51) Int. Cl. F42B 33/00; B29C 65/48; B29C 65/00

(52) U.S. Cl. CPC F42B 33/001; B29L 2031/7772; B29C 66/612; B29C 65/4845

(57) ABSTRACT

A non-contact jet valve applicator is used to inject sealant into a joint of an ammunition cartridge, including a circumferential case mouth joint and/or primer cup joint. A sealant is selected with adhesive properties to set a pull strength of the cartridge. In a crimped cartridge, the pull strength set by the adhesive sealant is greater than a pull strength otherwise generated by the crimp.

### CROSS-REFERENCE TO RELATED APPLICATION

This application claims the benefit of U.S. Provisional Patent Application Ser. No. 62/747,947, filed on Oct. 19, 2018, the contents of which are herein incorporated by reference in their entirety.

### FIELD OF THE INVENTION

The present invention relates to self contained ammunition, and more particularly, to achieving desired bullet pull strength in small arms ammunition using adhesive sealants and related methods of sealant application.

### BACKGROUND OF THE INVENTION

Consistency is the key to accuracy in a user's experience with ammunition. The consistency of ammunition is typically measured by analyzing the proximity of impacts or “tightness” of a shot grouping of bullets fired under specified conditions. The shot grouping is judged by measuring the distance between the centers of the most disparate impacts of the bullets. Anything which can bring the shot grouping into a more coincident and concentric pattern affords an increase in accuracy.

Bullet pull strength is the force necessary to separate a bullet from the cartridge case and is one of the many factors that affects the precision of the ammunition. The bullet pull strength can vary with each type and size of ammunition and can even vary from cartridge to cartridge within the same type and caliber. In particular, if the bullet pull strength varies or is inconsistent around the circumference of the bullet, that variation will often translate into reduced accuracy due to varying shot start velocities, leading to irregular trajectories and impacts of the bullets.

Bullet pull strength is a result of the interaction between the bullet and the cartridge case mouth. Several things may affect the bullet pull strength. For example, the relationship between the bullet diameter and the cartridge casie mouth diameter, hardness of the cartridge case or material finish of the case mouth inner walls, bullet material and presence or absence of a metal jacket, and mouth crimp may affect the bullet pull strength. Traditionally, the primary method to control bullet pull strength when designing a cartridge included making physical alterations to the case and bullet to adjust the fit of the bullet. One example of this is circumferential crimping around the case mouth. Crimping is done to set the minimum force needed to extract the bullet. Crimping also serves to lock the cartridge case mouth inside a bullet cannelure to prevent pushing in or pulling out of the bullet during cycling through the weapon or recoil. However, crimping adds another variable which can lead to inconsistent bullet pull strength.

The use of adhesive sealants is known in the ammunition field for purposes unrelated to bullet pull strength. For example, U.S. Pat. No. 6,460,464 (filed Jul. 7, 2000—the contents of which are herein incorporated by reference in their entirety) discloses the use of ultraviolet (UV) anaerobic cured sealant for sealing the circumferential joint between the primer cup and the back end of the case. However, existing methods used to apply such sealants limit their usefulness in high-volume ammunition assembly processes.

### SUMMARY OF THE INVENTION

In view of the foregoing, a method of achieving desired bullet pull strength using adhesive sealants is disclosed. The method includes providing a cartridge having a case and a projectile partially inserted into a case mouth forming a circumferential joint between the projectile and the case mouth. An adhesive sealant is applied to the circumferential joint, which sets the desired bullet pull strength.

According to an aspect of the invention, the circumferential joint is also crimped and the desired bullet pull strength set by the application of the adhesive sealant exceeds a pull strength of the crimping.

The method also includes providing a plurality of adhesive sealants, where each adhesive sealant of the plurality of adhesive sealants has a design bullet pull strength that is different from each other adhesive sealant. In addition, the method includes selecting a particular adhesive sealant from the plurality of adhesive sealants in order to achieve a desired design bullet pull strength, applying the particular adhesive sealant to the circumferential joint, and curing the adhesive sealant. Curing the adhesive sealant can include exposing the particular adhesive sealant to ultraviolet (UV) or other radiation until the particular adhesive sealant cures to develop the design bullet pull strength.

According to a further aspect of the invention, a method for applying an adhesive sealant to ammunition joint includes injecting the adhesive sealant into at least one joint using a non-contact jet valve. The ammunition joint can include a primer cup circumferential joint, a case mouth circumferential joint, or both joints.

These and other objects, aspects and advantages of the present invention will be better appreciated in view of the drawings and following detailed description of preferred embodiments.

### BRIEF DESCRIPTION OF DRAWINGS

FIG. 1A is an exploded schematic view of a cartridge;

FIG. 1B is a schematic view of the cartridge of FIG. 1A with a projectile inserted into a cartridge case;

FIG. 2 is a schematic view of a back end of the cartridge case of FIG. 1A taken in the direction of line 2-2;

FIG. 3 is a schematic view of applicators applying adhesive sealants in accordance with the invention; and

FIG. 4 is a schematic view of UV lights curing the adhesive sealants shown in FIG. 3.

### DETAILED DESCRIPTION OF PREFERRED EMBODIMENTS

In the summary of the invention, provided above, and in the descriptions of certain preferred embodiments of the invention, reference is made to particular features of the invention, for example, method steps. It is to be understood that the disclosure of the invention in this specification includes all possible combinations of such particular features, regardless of whether a combination is explicitly described. For instance, where a particular feature is disclosed in the context of a particular aspect or embodiment of the invention, that feature can also be used, to the extent possible, in combination with and/or in the context of other particular aspects and embodiments of the invention, and in the invention generally.

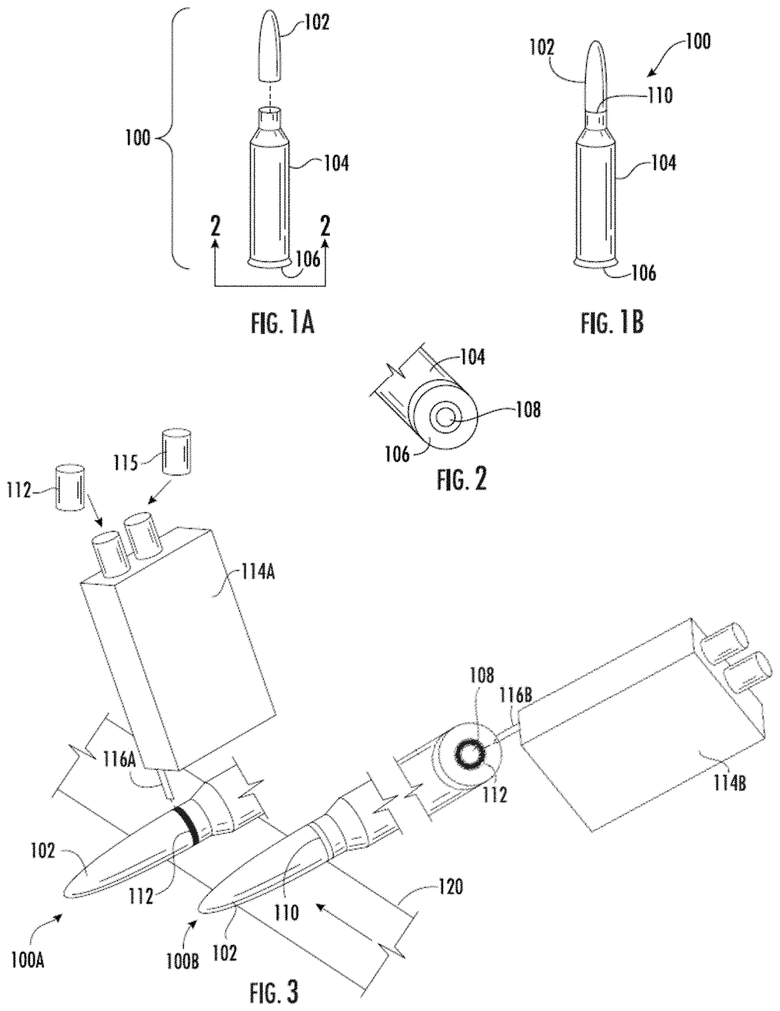

Referring initially to FIGS. 1A-1B and 2, a conventional cartridge 100 includes a projective 102 (i.e., the bullet) held partially within a cartridge case 104 forming a circumferential joint 110 between the projectile and the case mouth. The case 104 also contains a propellant for ejecting the bullet 102 from the case 104 when the cartridge 100 is fired. The case 104 also includes a back end 106 opposite the bullet 102 housed in the case mouth. The back end 106 typically provides a rim for gripping by an ejector mechanism of the firearm and houses a primer cup 108, which is ignited when struck with a firing pin, and which in turn ignites the propellant. The bullet 102 and case 104 can both be made of various suitable materials, including but not limited to, metals and polymers.

Referring additionally to FIG. 3, an adhesive sealant 112 is being applied to a plurality of cartridges 100A, 100B on a first production line 120 into the cirumferential joint between the bullet and the case mouth, as well as into the circumferential joint between the back end 106 and the primer cup 108. The adhesive sealant 112 applied to the case mouth joint is selected in order to set the bullet pull strength by bonding the projectile 102 to the case 104 in accordance with an aspect of the invention. The adhesive sealant 112 is formulated to adhere to the case 104 and the projectile 102 with a defined shear strength along the circumferential joint 110. Thus, selecting a particular adhesive sealant 112 determines the pull strength needed to separate the projectile 102 from the case 104.

As discussed above, crimping a cartridge casing 104 adds variables that can interfere in the bullet pull strength consistency. The consistency and efficacy of the bullet to case fit and crimp is subject to tool wear, machine settings, cannelure depth, cannelure style and many more factors. Because of the negative effect on accuracy of these variables, it is common to reduce or eliminate the tension, angle, length and depth of the case mouth crimp for match type ammunition (sniper grade, etc.), where the cartridge is usually not fired in automatic weapons. Doing this reduces the crimping force as a variable on the accuracy of the cartridge, avoiding potential issues associated with crimping with the goal of producing a more consistent bullet pull strength. However, unsuppressed crimping is necessary for most ammunition types and uses.

A plurality of adhesive sealants are provided 112, 115, where use of each adhesive sealant of the plurality of adhesive sealants 112, 115 will result in a design bullet pull strength that is different from each other adhesive sealant. In a particular aspect of the invention, each of the adhesive sealants 112, 115 masks crimping variables by exceeding the pull strength otherwise provided by the crimp force (or crimping can be omitted altogether in favor of the adhesive sealant), reducing the consequences of the variables of crimping and homogenizing the final bullet pull strength. The adhesive sealants 112, 115 accomplish this masking effect through even distribution around the joint 110 formed between the cartridge case mouth and base of the projectile. This even distribution, due to the preferably low viscosity and wicking properties of the adhesive sealants 112, 11,5 result in uniform bullet pull strength and a consistent release and trajectory for the bullet.

Additionally, once the tension of the crimp and/or bullet to case fit has been exceeded, the variable bullet pull strengths of the adhesive sealant may be used to manipulate the force a fired bullet imparts to the rifling of the barrel through changes in shot start velocity. It is known that the barrel and receiver of a weapon form an unsupported vibratory beam where the muzzle of the barrel orbits in response to force imparted. Due to the vibration interaction of the various components, it is possible to modify the impact described above to “tune” the loading to produce greater accuracy by increasing or decreasing the shot start tension which would be impossible to consistently achieve by mechanical tension alone.

A particular adhesive sealant is selected from the plurality of adhesive sealants 112, 115 in order to achieve a desired design bullet pull strength. As illustrated in FIG. 3, the selected adhesive sealant 112 is applied using an applicator 114A that includes a non-contact precision jet valve 116A. The jet valve 116A applies the adhesive sealant 112 to the circumferential joint 110 between the bullet 102 and the case mouth. The plurality of adhesive sealants 112, 115 are specially formulated to exhibit very low viscosity and to wick around the cartridge case mouth along circumferential joint 110 resulting in a smooth, consistent distribution of the adhesive sealant 112.

Additionally, an application 114B with a non-contact precision jet valve 116B is also used to apply an adhesive sealant 112 to the circumferential joint between the primer cup 108 and the back end of 106 of the case 104. As setting a desired pull strength is not an issue with this joint, the adhesive sealant is generally selected for suitable fluid-tight integrity and hold during expected handling of the cartridges. As described above, the adhesive sealant is preferably formulated to wick around the circumferential joint.

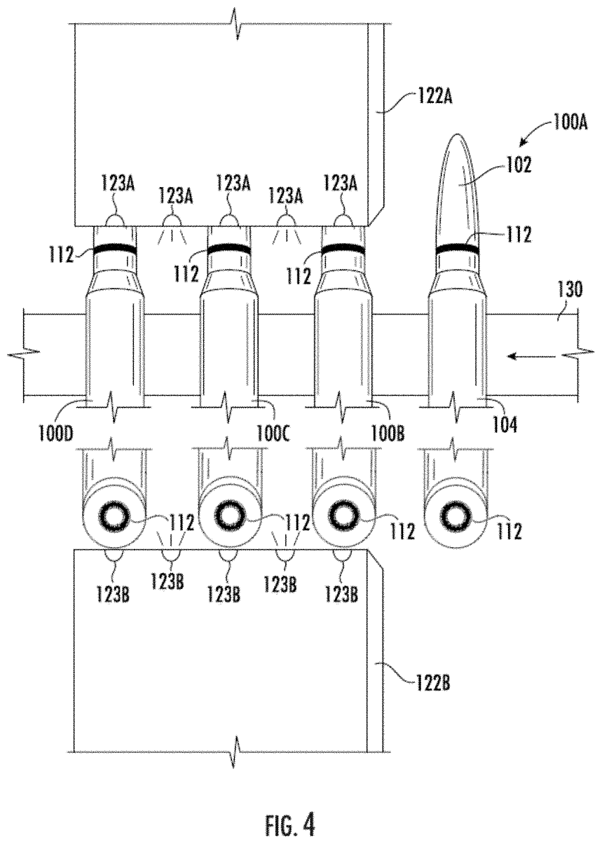

Referring now to FIG. 4, the adhesive sealants 112 are then cured in place on cartridges 100A, 100B, 100C, 100D on a second production line 130 (which may be a continuation of the first production line 120) using UV light assemblies 122A, 122B having respective arrays of UV LED curing lights 123A, 123B. At the appropriate wavelength and intensity, the UV exposure time requires can be a few second or less. Further subsurface curing in the circumferential joint occurs anaerobically. The particular adhesive sealant 112 is exposed to UV radiation until the particular adhesive sealant cures to the point where it will develop the desired bullet pull strength. After UV radiation curing is completed, the cartridges 100A, 1006, 100C, 100D, can be handled, tested, packaged and shipped in minutes without ever leaving the assembly line. It will be appreciated that adhesive sealants cured by other means could also be employed; for instance, adhesive sealants cured by visible light.

In a particular aspect of the invention, the adhesive sealant 112 may have a composition comprising polyglycol dimethacrylate of 30-60% by weight, polyglycol dioctanoate of 30-60% by weight, saccharin of 1-5% by weight, cumene hydroperoxide of 1-5% by weight, and a photoinitiator of 1-5% by weight.

The adhesive sealant 112 contains no class 1 ozone depleting chemicals. Accordingly, an additional advantage of the adhesive sealant 112 described herein is that it is 100% active with no solvents. This eliminates the toxic fumes and allows the adhesive sealant 112 to be applied continuously creating efficiency gains over previous batch processing methods.

The adhesive sealant 112 may maximize bullet pull strength at approximately 300 lbf. As bullet pull strength increases, so does the pressure inside the cartridge casing 104 prior to the bullet 102 firing. Accordingly, the adhesive sealant 112 may be formulated for a range of bullet pull strengths. For example, the bullet pull strength range may be from 125 lbf to 300 lbf. In addition to the bonding force of the adhesive, the overall pull strength is also varied based on the surface area available for bonding/sealing—which can vary based on caliber and other dimensional factors.

In general, the foregoing description is provided for exemplary and illustrative purposes; the present invention is not necessarily limited thereto. Rather, those skilled in the art will appreciate that additional modifications, as well as adaptations for particular circumstances, will fall within the scope of the invention as herein shown and described and of the claims appended hereto.

What is claimed is:

1. A method of applying a sealant to a circumferential joint in ammunition, the method comprising:
moving a cartridge along a production line to an applicator having a non-contact jet valve;
using the jet valve to inject the sealant into the circumferential joint; and
exposing the injected sealant to ultraviolet (UV) light on the production line to at least partially cure the sealant.

2. The method of claim 1, wherein the sealant is formulated to wick around the circumferential joint when injected.

3. The method of claim 1, wherein the circumferential joint is at least one of:
a joint between a projectile and a case mouth of the cartridge; and
a joint between a primer cup and a back end of a case of the cartridge.

4. The method of claim 3, wherein the production line further includes an additional applicator having an additional non-contact jet valve, using the jet valve includes injecting the sealant into the joint between the projective and the case mouth, and the method further includes using the additional jet valve to inject an additional sealant into the joint between the primer cup and the back end of the case.

5. The method of claim 1, wherein the sealant is an adhesive sealant.

6. The method of claim 5, wherein the circumferential joint is between a projectile and a case mouth of the cartridge and the adhesive sealant is formulated to achieve a desired pull strength at the circumferential joint.

7. The method of claim 6, wherein a crimp is also formed around the case mouth to engage a cannelure in the projectile and the desired pull strength achieved by the adhesive sealant is greater than a pull strength otherwise provided by the crimp.

8. The method of claim 6, wherein the case mouth is uncrimped.

9. The method of claim 6, wherein the desired pull strength is at least 125 pounds force (lbf).

10. The method of claim 9, wherein the desired pull strength is from 125 lbf to 300 lbf inclusive.

11. A method of achieving a desired pull strength in an ammunition cartridge, the method comprising:
selecting an adhesive sealant to achieve the desired pull strength;
applying the adhesive sealant to a circumferential joint between a projectile and a case mouth of the cartridge; and
curing the adhesive sealant.

12. The method of claim 11, wherein the adhesive sealant is injected into the circumferential joint using an applicator having a non-contact jet valve.

13. The method of claim 12, wherein the adhesive sealant is formulated to wick around the circumferential joint.

14. The method of claim 11, wherein curing the adhesive sealant includes at least partially curing the adhesive sealant using ultraviolet (UV) light.

15. The method of claim 14, wherein the adhesive sealant and the UV light are both applied along a production line.

16. The method of claim 11, wherein a crimp is also formed around the case mouth to engage a cannelure in the projectile and the desired pull strength achieved by the adhesive sealant is greater than a pull strength otherwise provided by the crimp.

17. The method of claim 11, wherein the case mouth is uncrimped.

18. The method of claim 11, wherein the desired pull strength is at least 125 pounds force (lbf).

19. The method of claim 18, wherein the desired pull strength is from 125 lbf to 300 lbf inclusive.

20. An ammunition cartridge comprising:
a case having a case mouth;
a projectile at least partially inserted into the case mouth such that a circumferential joint is formed therebetween; and
an adhesive sealant located in the circumferential joint binding the case mouth to the projectile;
wherein a pull strength of the cartridge is determined by a formulation of the adhesive sealant.

21. The ammunition cartridge of claim 20, wherein a crimp is formed around the case mouth engaging the projective, the pull strength of the cartridge determined by the formulation of the adhesive sealant being greater than a pull strength otherwise determined by the crimp.

22. The ammunition cartridge of claim 20, wherein the case mouth is uncrimped.
